(19) United States
(12) Patent Application Publication
(10) Pub. No.: US 2026/0023754 A1
(43) Pub. Date: Jan. 22, 2026

(54) CONTENT ADAPTIVE DATA ARRAY WITH A SHARED SCALE AND TYPE SELECTOR BIT

(71) Applicants: Advanced Micro Devices, Inc., Santa Clara, CA (US); XILINX, INC., San Jose, CA (US)

(72) Inventors: Adam LI, San Diego, CA (US); Alireza KHODAMORADI, Lafayette, CO (US); Benjamin T. SANDER, Austin, TX (US); Eric DELLINGER, Longmont, CO (US); Kristof DENOLF, Longmont, CO (US); Philip JAMES-ROXBY, Longmont, CO (US); Ralph D. WITTIG, Menlo Park, CA (US)

(21) Appl. No.: 18/778,625

(22) Filed: Jul. 19, 2024

(51) Int. Cl. G06F 16/25

(52) U.S. Cl. CPC G06F 16/258

(57) ABSTRACT

Embodiments herein describe a content adaptive array that can include different types of data. In content adaptive arrays, the datatype of the array can vary depending on the actual values of the data in the array. For example, for arrays where the data values have a small dynamic range, an INT4 datatype may be preferred since it can provide the most accuracy and still avoid underflow. For arrays where the data values have larger dynamic ranges, an FP datatype may be preferred since it provides more dynamic range. The content adaptive array can include metadata (e.g., type selector bits) that indicates what the datatype of the data in the array. Thus, when the hardware receives the array, it can use the metadata to identify the datatype of the data and then process the array accordingly.

### TECHNICAL FIELD

Examples of the present disclosure describe arrays used in machine learning (ML) applications that include different datatypes.

### BACKGROUND

Machine Learning (ML) and Artificial Intelligence (Al) models typically use large amounts of data in vectors, matrices, and tensors (referred to collectively herein as arrays). These data structure can be the input/output of the model, the model weights, the activations, or other data used in the computation. For ML applications (as well as other applications) the entire array (e.g., matrix, vector, or tensor) is in one datatype. For example, there can be floating point (FP) array (e.g., a FP32 array, an integer array (e.g., INT8 integer vector), etc. Once the datatype is chosen, the entire array is represented in that datatype. This enables downstream hardware (e.g., matrix multipliers) to either process the data in the array directly, or to convert the data in the array to a datatype that is compatible with the hardware and then process the data.

### SUMMARY

One embodiment described herein is a compute unit that includes circuitry configured to receive an array where the array includes multiple data values, a shared scale for scaling each of the data values, and one or more type selector bits, the one or more type selector bits indicating a datatype of at least one of the data values. The circuitry is also configured to process the data values based on the shared scale and the one or more type selector bits.

Another embodiment described herein is a compute system that includes memory configured to store an array where the array includes multiple data values, a shared scale for scaling each of the data values, and one or more type selector bits, the one or more type selector bits indicating a datatype of at least one of the data values. The system also includes a compute unit configured to receive the array from the memory and process the data values based on the shared scale and the one or more type selector bits.

Another embodiment described herein is a compute unit that includes circuitry configured to receive an array of data for a machine learning (ML) application where the array includes multiple data values and type selector bits indicating a first data value of the data values is a first datatype and a second data value of the data values is a second datatype different from the first datatype and process the data values based on the type selector bits.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of a ML system for compressing data using a content adaptive array, according to one embodiment.

FIG. 2 illustrates a one dimensional (1D) content adaptive array, according to one embodiment.

FIG. 3 illustrates a 1D content adaptive array that is divided into groups, according to one embodiment.

FIGS. 4 and 5 illustrate a two dimensional (2D) content adaptive array that is divided into groups, according to one embodiment.

FIG. 6 illustrates a 2D content adaptive array that is divided into groups with additional scale offsets, according to one embodiment.

FIG. 7 illustrates a 1D content adaptive array that is divided into groups with additional scale offsets, according to one embodiment.

FIG. 8 is a flowchart for processing a content adaptive array, according to one embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described

Embodiments herein describe a content adaptive array (e.g., a vector, matrix, tensor, etc.) that includes different types of data. As mentioned above, when a ML application is configured for execution, the datatypes are set (e.g., known or fixed). As such, the hardware knows what datatypes to expect, and is either delivered data it is compatible with, or is able to convert the data into a type it is compatible with. However, it may be advantageous to compress data (e.g., quantization data) into datatypes with fewer bits, especially when transmitting the data to or from memory. That is, when processing the data, to preserve accuracy, the ML system may want to process high-precision data (e.g., FP32), but when storing the data, it may be advantageous to compress the data (e.g., INT4, FP4, microscaling FP (MXFP4), block floating point (BFP4) etc.). This can save bandwidth, reduce memory usage, save power, and the like.

However, compressing the data in an array into the same datatype may result in some data values underflowing (which is just one example of a quantization error that may occur). These smaller datatypes often include a shared scale value. If the values in the array have a large dynamic range (e.g., the values have larger distributions), then converting from a FP32 to FP4/INT4/MXFP4/BFP4 can mean the data values at the lower ends of the distributions can underflow (e.g., be converted to zero) which means these data values are lost. As such, compressing all the data in an array into the same datatype can result in lost information.

Instead, the embodiments herein describe using content adaptive arrays where the datatype of the array can vary depending on the actual values of the data in the array. For example, for arrays where the data values have a small dynamic range (e.g., a tight distribution of values), an INT4 datatype may be preferred since it can provide the most accuracy and still avoid underflow. For arrays where the data values have larger dynamic ranges, an FP datatype may be preferred since it provides more dynamic range. However, since the datatype can change, the hardware (or software) tasked with processing the array might not know the datatype when it receives the array. That is, to hardware, an INT4 array can have the same size as a FP4 array even though the meaning of the data values is different. As such, the content adaptive array can include metadata (e.g., type selector bits) that indicates the datatype of the data in the array. Thus, when the hardware receives the array, it can use the metadata to identify the datatype of the data and then process the array accordingly (e.g., convert it to a different datatype it is compatible with). In this manner, the datatype in any array can change (i.e., adapt) according to the values of the data in the array.

In one embodiment, the content adaptive array can store multiple datatypes. For example, a first sub-portion of the array may have INT4 data values while a second sub-portion of the array has FP4 data values. For example, the first sub-portion may include data values with a small dynamic range making it better suited for INT4 while the second sub-portion includes data values with a higher dynamic range, making FP4 a better choice to avoid underflow. The metadata for the array can include at least one type selector bit for the first sub-portion and another type selector bit for the second sub-portion. The hardware receiving the array can use the type selector bits to identify the different datatypes in the array. In this manner, an array can include different datatypes within it, which can further improve accuracy of the ML operations.

In one embodiment, the arrays can also include scale offsets for each sub-portion of the array. That is, in addition to having one or more type selector bits for each sub-portion, the array can include additional scale offsets for the data in each sub-portion. These scale offsets can be used to scale each sub-group in the array, along with a shared scale for entire array. However, different datatypes could be used in lieu of having scale offsets for each sub-portion of the array. For example, the datatypes could have a “baked in” scale offset, such as a first datatype that is a non-scaled FP4, a second datatype that is FP4 divided by two, a third datatype that is FP4 divided by four, etc. In this example, the type selector bits could indicate different types of scaled datatypes that can correspond to each sub-portion or group in the array.

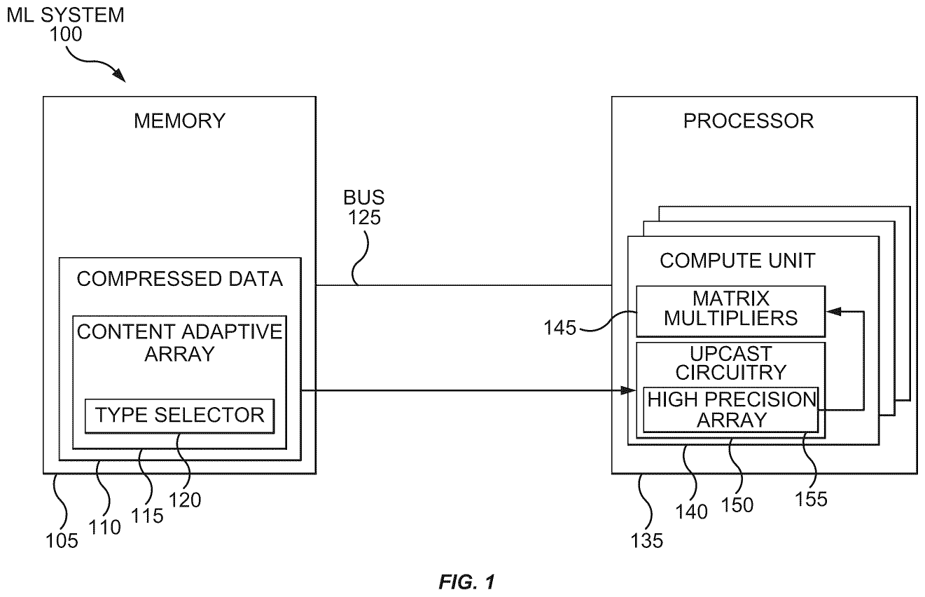

FIG. 1 illustrates a block diagram of a ML system 100 for compressing data using a content adaptive array 115, according to one embodiment. While the embodiments herein are discussed in the context of a ML or artificial intelligence (AI) system, they are not limited to such. That is, the content adaptive array 115 could be used in other applications to compress and move data to and from memory, such as distributed computing systems or computing systems that execute parallel computing workloads across multiple nodes.

With ML applications, large amounts of data such as weight tensors, activations, input/output, and the like are frequently moved from memory 105 to compute units 140 that perform ML operations (which often includes matrix multiplications). The memory 105 may be main memory (e.g., RAM), storage (e.g., solid state drives or hard disk drives), as well as any number of cache levels (e.g., L2/L3 cache). The memory 105 is coupled to the processor 135 via a bus 125.

The processor 135 includes compute units 140 for performing the ML operations using the content adaptive array 115. In this example, the compute units 140 include matrix multipliers 145, but this is only one example of circuitry that may be in the compute units 140.

The processor 135 can be a central processing unit (CPU), a graphics processing unit (GPU), a field programmable gate array (FPGA), a system on a chip (SoC) that includes an array of artificial intelligence (Al) engines, and the like. For example, the compute units 140 may be cores in a CPU, or a workgroup or a processing tile in a GPU. The compute units 140 may include vector processors (e.g., single instruction, multiple data (SIMD)) or streaming multiprocessors (SM) and memory (e.g., registers). Moreover, the compute units 140 can be assigned to workgroups by a programmer to execute wavefronts. In other examples, one or more compute units 140 may be assigned to a kernel. If the processor 135 is an FPGA, the compute units 140 may be formed using programmable logic (in contrast to hardened circuitry or hardened logic).

The bandwidth in the bus 125, and the storage in the memory 105 may be limited. As such, it is advantageous to store the content adaptive array 115 using a datatype with smaller bits (e.g., FP4 or INT4 versus FP8, INT8, or FP32). As such, the compressed data 110 uses less space in the memory 105, and uses less bandwidth when traversing the bus 125.

However, it also may be advantageous to convert the compressed data 110 into a high precision array 155 before it is processed in the compute unit 140 (e.g., before performing matrix multiplication using the matrix multipliers 145) since this can improve accuracy. For example, matrix multiplications can be used to perform convolution, linear regression, updating weights during training, etc. Moreover, the matrix multipliers 145 may not be compatible with the datatype in the content adaptive array 115. For these reasons, the compute units 140 include upcast circuitry 150 which can convert the compressed content adaptive array 115 into a high precision array 155. This can include changing the data values to datatypes that include more data bits (e.g., FP4 to FP8 or FP32) as well as changing between different categories of datatypes (if necessary) (e.g., from an INT to a FP datatype).

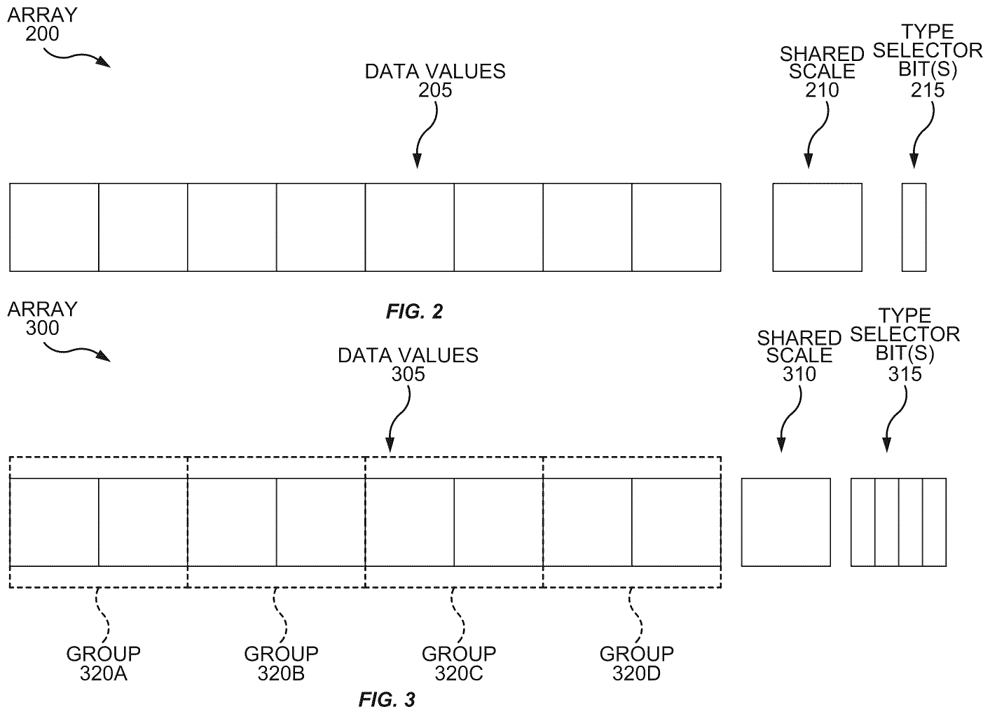

The content adaptive array 115 includes a type selector 120 which can include one or more bits indicating the type of the data values in the array 115. In one embodiment, the type selector 120 is metadata about the data values since it describes the data values but does not directly affect their values (unlike a scale factor or exponent). The upcast circuitry 150 can use the type selector 120 to determine how to upcast the data values or whether the upcast circuitry 150 should convert the data values to a different type. Different types of content adaptive arrays 115 are described in FIGS. 2-7.

While FIG. 1 illustrates using the compressed adaptive content array 115 as the transport datatype when moving data into (and out of) the compute units 140, this is just one example. In the ML/AI applicants, the datatypes evolve toward shorter types. The motivation is to perform more operations quicker, and shorter datatypes are easier and faster to operate on. As such, the ML system may process data in the compute units 140 using the same datatype that was used to transport the data to the compute units 140.

As datatypes get shorter, choosing datatypes for a data array has become increasingly more challenging. The challenge with shorter datatypes is preserving as much information as possible. As such, having greater flexibility when selecting datatypes can result in retaining more information and improving the accuracy of the model.

The datatype choice can depend on the characteristics of the array it represents. The range, distribution, ML model performance, and many other characteristics are important in deciding which datatype would best suit a specific array. To make things even more challenging, these characteristics could also change and evolve as the model is trained. Moreover, different parts of the same array might exhibit different characteristics. As such, adding a type selector 120 that permits array to change to different datatypes, and/or contain multiple different datatypes in the same array 115 can add flexibly to resolve these issues.

In another embodiment, rather than having upcast circuitry 150, the matrix multipliers 145 may support different datatypes where upcasting can be done within the matrix multipliers 145. That is, rather than having matrix multiplies 145 that can support high precision data, the matrix multipliers may be able to directly receive the compressed data 110 as an input. In one embodiment, the matrix multipliers could support (or receive as input) compressed data (e.g., INT4, MXFP4, BFP4, etc.) or high precision data (e.g., MXFP8, MXFP16, MXFP32, etc.). For example, the matrix multipliers may take the type selector 120 as an input and perform the matrix multiplication based on the type selector 120. The matrix multipliers 145 can perform an integrated upcast function when performing the matrix multiplications. In this manner, the upcast circuitry 150 may be omitted from the compute path.

FIG. 2 illustrates a 1D content adaptive array 200, according to one embodiment. For example, the array 200 can be a vector that includes data values 205, a shared scale 210, and type selector bit(s) 215. In the context of ML/AI, the data values 205 can be weights, input/output data, activations, etc. In one embodiment, the bits or size of each of the data values 205 is the same. For example, the eight data values 205 may each have four bits. Of course, this is just one example, and the array 200 can be much larger, and the number of bits in each data value 205 can be greater (e.g., 8, 16, 32, etc.).

The shared scale 210 is a value that scales each of the data values 205. For example, the shared scale 210 may serve as a common exponent (or a power of two scale) for the data values 205. The shared scale 210 is especially useful for smaller datatypes (e.g., four bits or less) to help provide additional dynamic range and preserve accuracy. For example, if the datatypes are integers (e.g., INT4), the shared scale 210 can serve as an exponent value for the values 205 when they are upcast.

However, in some cases, the shared scale 210 may be omitted since the data values 205 themselves may have a sufficient number of bits to accurately represents the values. That is, the embodiments herein are not limited to arrays 200 that include data values with a shared scale 210.

The type selector bit can indicate the datatype of the data values 205. For example, if the type selector bit 215 is a single bit, this means the data values 205 could be two different datatypes (e.g., a logical one can indicate the data values 205 are INT4 while a logical zero indicates the data values 205 are FP4). If the type selector bits 215 has two bits, the data values 205 can be four different datatypes (e.g., “00” indicates INT4, “01” indicates FP4, “10” indicates MXFP4, and “11” indicates BFP4). Designating more bits as the type selector bits 215 provides greater flexibility when determining the datatypes. Put differently, the ML system can select from a larger pool of different datatypes for the data values 205 as more bits are assigned to the type selector bits 215.

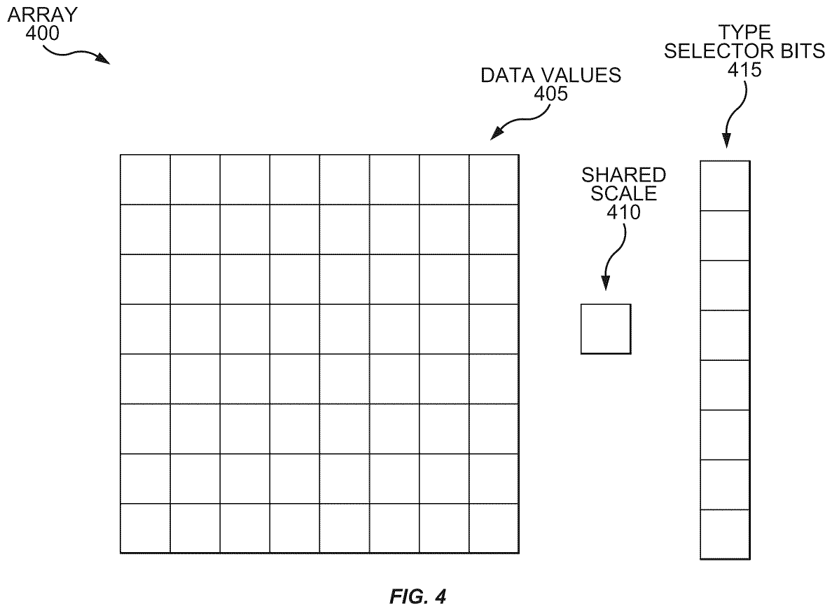

FIG. 3 illustrates a 1D content adaptive array 300 that is divided into groups 320, according to one embodiment. In this example, the array 300 includes eight data values 305 along with a shared scale 310, like the array 200 in FIG. 2. However, these eight data values 305 are divided into four groups 320A-D. The array 300 also includes four type selector bits 315 where each bit corresponds to one of the groups 320. That is, a first bit of the bits 315 indicates the datatype of the data values 305 in group 325A, a second bit of the bits 315 indicates the datatype of the data values 305 in group 325B, a third bit of the bits 315 indicates the datatype of the data values 305 in group 325C, and a fourth bit of the bits 315 indicates the datatype of the data values 305 in group 325D.

While FIG. 3 illustrates two data values in each group 320, in practical implementations, an array 200 would likely have many more data values, which means the groups 320 would be larger. The greater number of data values 305 means the greater likelihood that the dynamic range or distribution of the data values 305 is large which increases the risk of underflow. Dividing the data values 305 into groups 320 reduces the risk of underflow since data values in each group can be assigned to different datatypes. For example, if the data values in group 320A are quite different, then a FP datatype may be used for these values to prevent underflow. However, if the data values in group 320B are similar, a INT datatype may be used to improve accuracy. In this manner, the same array 300 can have data values 305 represented using different datatypes, which is tracked by the type selector bits 315.

In one embodiment, when the array 300 includes data values 305 represented as different datatypes, the data values 305 still have the same number of bits (e.g., the same size). Thus, data values 305 that represent INTs have the same number of bits as data values 305 in the array 300 that are FPs. As such, in this example, the array 300 would not have data values 305 with different numbers of bits or sizes (e.g., FP8 and FP4, or INT4 and FP8). Having consistent sizes of the data values 305 can help the hardware to identify the different data values 305 within the array when processing the array 300.

To support more datatypes, multiple type selector bits can be used for each group 320. For example, the type selector bits 315 can include two bits for each group 320 (8 bits total) so that the ML system can select from four different datatypes. In one embodiment, the number of groups 320 can be balanced with the number of datatypes that the ML system supports. For example, by decreasing the number of groups 320, this means more bits are available to encode additional datatypes. For instance, if the array 300 had two groups 320 rather than four, then two of the bits of the type selector bits 315 can be used to encode the datatypes for each of the two groups, rather than having one bit for each of the four groups shown in FIG. 3.

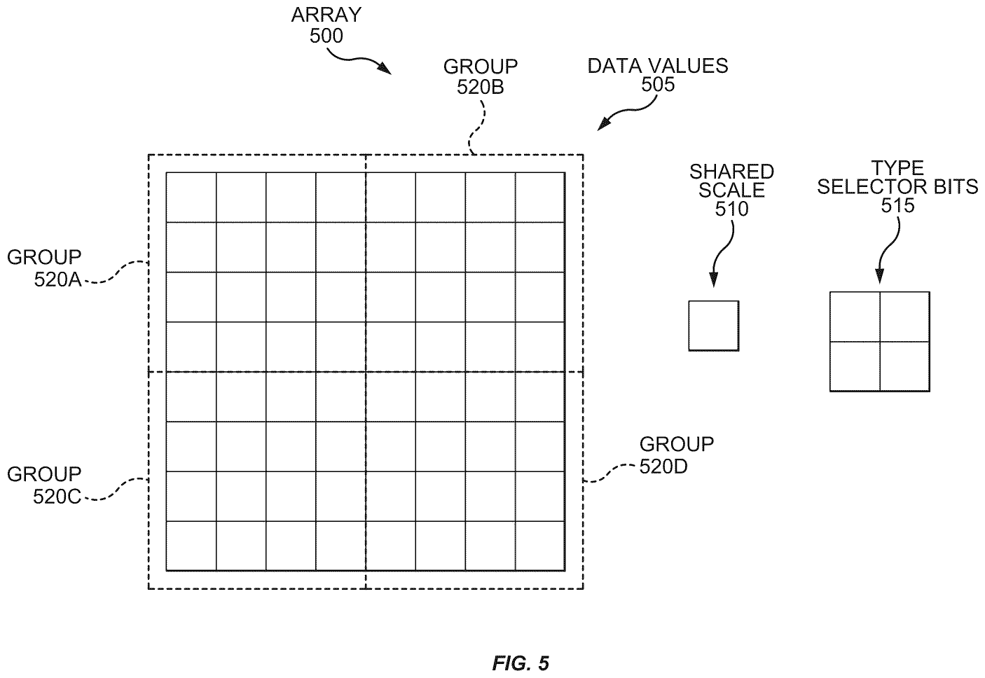

FIGS. 4 and 5 illustrate a 2D content adaptive array that is divided into groups, according to one embodiment. In these figures, the content adaptive array is a matrix (also referred to as a tile) that includes rows and columns of data values.

The content adaptive array 400 in FIG. 4 includes a matrix of data values 405 which are scaled by the shared scale 410. In this example, the array 400 also includes type selector bits 415 for indicating the datatype of each row of the data values 405. Since there are eight rows of data values 405, the type selector bits 415 include at least eight bits where one of the bits indicates the datatype for one of the rows. However, in another embodiment, the type selector bits 415 can indicate the datatype for each column in the matrix.

As discussed above, the type selector bits 415 can include multiple bits for each row so that the ML system can support more than two different datatypes-e.g., using two bits for each row (16 bits total) means that four datatypes could be used, and so forth.

Unlike in FIGS. 2 and 3 where each row has a shared scale, here, the entire matrix of data values 405 uses the same shared scale 410. Thus, the bits saved by not having a shared scale per row can be used for the type selector bits 415 and/or to make the shared scale 410 larger. Thus, each row (or column) of the data values 405 can be assigned a different datatype. Further, multiple type selector bits can be assigned to each row so that additional datatypes can be supported.

Further, while FIG. 4 illustrates having at least one type selector bit 415 for each row, in another embodiment, there may be one or more type selector bits 415 that indicate the datatype for each of the data values 405 in the array 400—i.e., one or more type selector bits 415 for all the data values 405 in the entire array 400. This can be still be advantageous since when the array 400 is first generated, the data values 405 may have similar values, and thus, representing them as INTs may preserve the most information as the array 400 is upcast/downcast. However, over time (e.g., during training), the dynamic range of the values 405 may increase. The ML system may switch to using FP values to represent the data values 405 in order to avoid underflow. Thus, while it may be more accurate to have type selector bits 415 for each row or column, this also uses more bits. Having one or more type selector bits to indicate the datatype for every data value 405 in the array 400 can save bits but still support changing the datatype as the data values 405 change.

Moreover, using the shared scale 410 with a matrix can be especially advantageous during training. On a backward pass of a training step (e.g., when performing back propagation), the inner dimension of the matrix is a different dimension that the tensor which means the shared exponents are not mathematically correct because they are on a different axis. The typical technique to avoid this problem is to quantize to a square tile so the system does have to re-quantize on a backwards pass. The alternative is the ML system would have to take the weights, fetch the original higher precision weights, transpose those, quantize those, and then do the matrix multiply which losses the benefit of using the smaller datatype. Using the shared scale 410 can avoid this re-quantization.

The content adaptive array 500 in FIG. 5 includes a matrix of data values 505 which are scaled by the shared scale 510. In this example, the array 500 also includes type selector bits 515 for indicating the datatype of multiple groups 520 in the array 500 (also referred to as sub-tiles). Since there are four groups 520A-D of data values 505, the type selector bits 515 include at least four bits where one of the bits indicates the datatype for one of the data values 505 in one of the groups 520.

As discussed above, the type selector bits 515 can include multiple bits for each group 520 so that the ML system can support more than two different datatypes—e.g., using two bits for each group (8 bits total) means that four datatypes could be used, and so forth. Thus, FIG. 5 illustrates that the same array 500 (or tile) can be divided into sub-tiles or sub-matrices which can have data formatted in different datatypes.

Like in FIG. 4, here, the entire matrix of data values 505 uses the same shared scale 510. Thus, the bits saved by not having a shared scale per row can be used for the type selector bits 515 and/or to make the shared scale 510 larger. Thus, each group 520 of data values 405 can be assigned a different datatype.

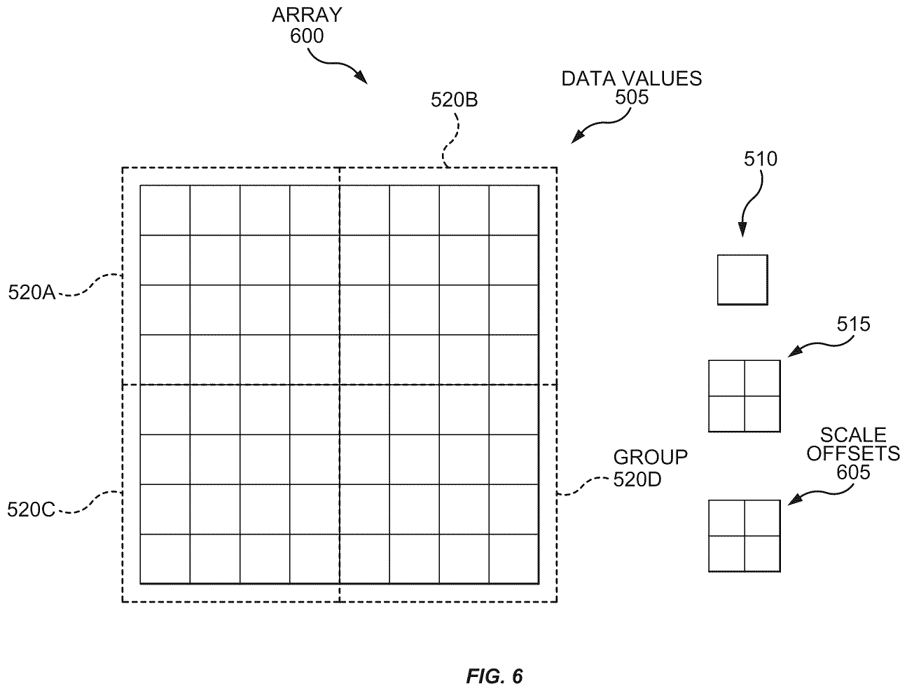

FIG. 6 illustrates a 2D content adaptive array 600 that is divided into groups with additional scale offsets, according to one embodiment. The array 600 is a modified version of the array 500 in FIG. 5, which includes the data values 505, the shared scale 510, and the type selector bits 515. In addition, the array 600 includes bits reserved for an scale offset 605 that can be applied to each group. That is, the scale offset 605 includes one or more bits for scaling the data values in group 520A, one or more bits for scaling the data values in group 520B, one or more bits for scaling the data values in group 520C, and one or more bits for scaling the data values in group 520D. The scale offset 605 for each group can be used in conjunction with the shared scale 410 (and any local exponent values stored in the data values, if applicable). For example, when upcasting a data value 505, upcast circuitry can scale the bits in the data value (which may or may not include an exponent value) using the group specific scale offset 605 and the shared scale 510 to generate a high precision data value. Stated differently, the per group scale offsets 605 can be stacked with the shared scale 510, along with any scale value or exponent in the data value 505 itself, to scale the data value 505. Thus, FIG. 6 illustrates a hierarchy or scale values or exponents where some exponents apply only to a particular data value 505, some apply only to a particular group or sub-tile, and the shared scale value 510 applies to the entire array 600 or tile.

In another embodiment, the type selector bits 515 can be used to perform the same (or similar) function as the scale offsets 605. For example, the type selector bits 515 can indicate a scaled datatype. For instance, using two bits for each group 520, the type selector bits could indicate whether the data values in the group 520 are FP4 (e.g., FP4 values that are not scaled), FP4 divided by two (e.g., FP4 values that are scaled by two), FP4 divided by 4 (e.g., FP4 values that are scaled by four), or FP8 divided by eight (e.g., FP4 values that are scaled by eight). In this example, the ML system can not only change between different datatypes, but also indicate the scale (on a per group basis) associated with the datatypes, thereby fulfilling the role of the scale offsets 605. In another example, using two bits for each group 520, the type selector bits could indicate whether the data values in the group 520 are INT4 (e.g., INT4 values that are not scaled), INT4 divided by two (e.g., INT4 values that are scaled by two), FP4 (e.g., FP4 values that are not scaled), or FP4 divided by two (e.g., FP4 values that are scaled by two). Thus, the ML system can use the type selector bits to switch between different datatypes, as well as different scales of those datatypes. Of course, by using more type selector bits per group, the ML system can support additional datatypes and different scales of those datatypes.

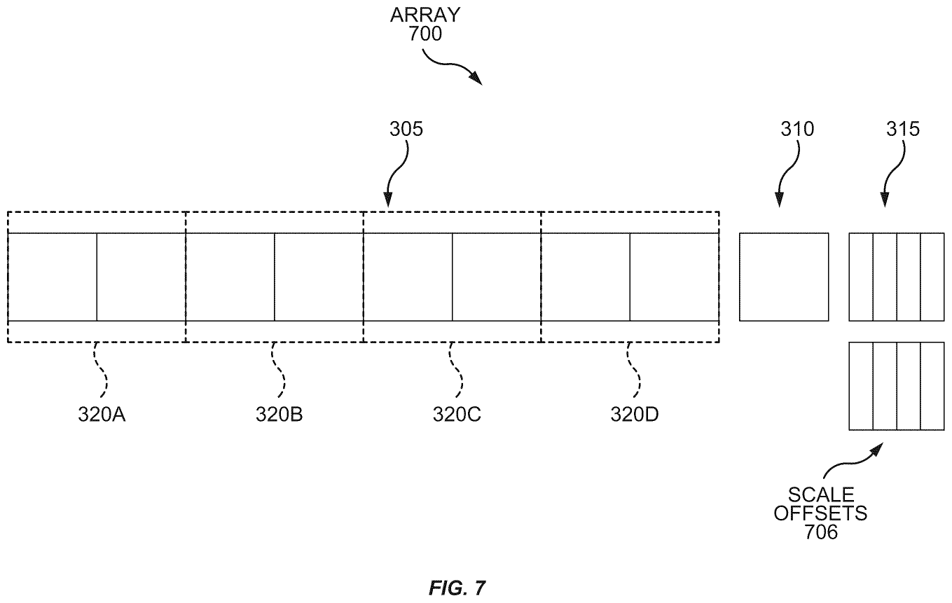

FIG. 7 illustrates a 1D content adaptive array 700 that is divided into groups 320 with additional scale offsets 705, according to one embodiment. The array 700 is a modified version of the array 300 in FIG. 3, which includes the data values 305, the shared scale 310, and the type selector bits 315. In addition, the array 700 includes bits reserved for an scale offset 705 that can be applied to each group. That is, the scale offset 705 includes one or more bits for scaling the data values in group 320A, one or more bits for scaling the data values in group 320B, one or more bits for scaling the data values in group 320C, and one or more bits for scaling the data values in group 320D. The scale offsets 705 for each group can be used in conjunction with the shared scale 510 (and any local exponent values stored in the data values 305, if applicable). Thus, FIG. 7 illustrates that scale offsets can be applied on a 1D array 700 as well as the 2D array 600 in FIG. 6.

Alternatively, as discussed in FIG. 6, the type selector bits 315 can be used to perform the same (or similar) function as the scale offsets 705. For example, the type selector bits 515 can indicate a scaled datatype (e.g., INT4 divided by two, FP4 divided by four, etc.). In that case, the scale offsets 705 can be omitted.

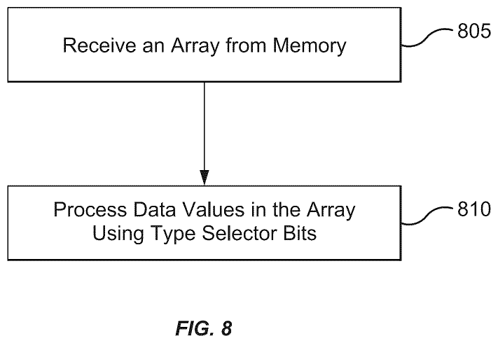

FIG. 8 is a flowchart for processing a content adaptive array, according to one embodiment. At block 805, a compute unit (e.g., the compute unit 140 in FIG. 1) includes circuitry that receives an array (e.g., a content adaptive array) from memory (e.g., the memory 105 in FIG. 1). The array can include multiple data values one or more type selector bits which indicate a datatype of at least one of the data values. For example, the type selector bits can indicate that a first data value of the data values is a first datatype and a second data value of the data values is a second datatype different from the first datatype.

In some embodiments, the array also includes a shared scale for scaling each of the data values. In some embodiments, the array also includes one or more scale offsets. The array can be any of the examples discussed above in FIGS. 1-7.

At block 810, the compute unit processes the data values in the array based on the one or more type selector bits. For example, the array can be part of a ML application where the compute unit includes matrix multipliers for processing the data values.

In one embodiment, the compute unit comprises upcast circuitry that converts the data values in the array from a first datatype to a higher precision datatype using the one or more type selector bits. The matrix multipliers can perform multiplications when the data values are in the higher precision datatype.

While FIGS. 2-8 illustrate using 1D or 2D content adaptive arrays, ML/AI applications can have arrays (or tiles) with any number of dimensions. Using type selector bits to indicate the datatype of the data values in the array, or using type selector bits to indicate the datatype of different groups/sub-tiles in the array, can be used regardless of the number of dimensions of the array. As such, the embodiments herein can be used to generate content adaptive arrays that have three, four, five, etc. number of dimensions.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

1. A compute unit, comprising:
circuitry configured to:
receive an array, the array comprising multiple data values, a shared scale for scaling each of the data values, and one or more type selector bits, the one or more type selector bits indicating a datatype of at least one of the data values; and
process the data values based on the shared scale and the one or more type selector bits.

2. The compute unit of claim 1, wherein the one or more type selector bits includes a plurality of type selector bits, wherein a first bit of the plurality of type selector bits indicates a first data value of the multiple data values is a first datatype and a second bit of the plurality of type selector bits indicates a second data value of the multiple data values is a second datatype.

3. The compute unit of claim 2, wherein the first bit of the plurality of type selector bits indicates at least two of the multiple data values are the first datatype and the second bit of the plurality of type selector bits indicates at least two of the multiple data values are the second datatype.

4. The compute unit of claim 3, wherein the at least two of multiple data values corresponding to the first bit comprises data values in at least two rows and at least two columns of the array and the at least two of multiple data values corresponding to the second bit comprises data values in at least two rows and at least two columns of the array.

5. The compute unit of claim 1, wherein the one or more type selector bits indicates that each of the data values are a same datatype, wherein the one or more type selector bits have different values for indicating each of the data values are different datatypes.

6. The compute unit of claim 1, wherein the array is part of a machine learning (ML) application, wherein the circuitry comprises matrix multipliers configured to process the data values.

7. The compute unit of claim 6, wherein the circuitry comprises upcast circuitry is configured to convert the data values in the array from a first datatype to a higher precision datatype using the one or more type selector bits, wherein the matrix multipliers are configured to perform multiplications when the data values are in the higher precision datatype.

8. The compute unit of claim 7, wherein the array is transmitted from memory to the compute unit when the data values are the first datatype.

9. A compute system, comprising:
memory configured to store an array, the array comprising multiple data values, a shared scale for scaling each of the data values, and one or more type selector bits, the one or more type selector bits indicating a datatype of at least one of the data values; and
a compute unit configured to:
receive the array from the memory, and
process the data values based on the shared scale and the one or more type selector bits.

10. The compute system of claim 9, wherein the one or more type selector bits includes a plurality of type selector bits, wherein a first bit of the plurality of type selector bits indicates a first data value of the multiple data values is a first datatype and a second bit of the plurality of type selector bits indicates a second data value of the multiple data values is a second datatype.

11. The compute system of claim 10, wherein the first bit of the plurality of type selector bits indicates at least two of the multiple data values are the first datatype and the second bit of the plurality of type selector bits indicates at least two of the multiple data values are the second datatype.

12. The compute system of claim 11, wherein the at least two of multiple data values corresponding to the first bit comprises data values in at least two rows and at least two columns of the array and the at least two of multiple data values corresponding to the second bit comprises data values in at least two rows and at least two columns of the array.

13. The compute system of claim 9, wherein the one or more type selector bits indicates that each of the data values are a same datatype, wherein the one or more type selector bits have different values for indicating each of the data values are different datatypes.

14. The compute system of claim 9, wherein the array is part of a ML application, wherein the compute unit comprises matrix multipliers configured to process the data values.

15. The compute system of claim 14, wherein the compute unit comprises upcast circuitry is configured to convert the data values in the array from a first datatype to a higher precision datatype using the one or more type selector bits, wherein the matrix multipliers are configured to perform multiplications when the data values are in the higher precision datatype.

16. The compute system of claim 15, wherein the array is transmitted from the memory to the compute unit when the data values are the first datatype.

17. A compute unit, comprising:
circuitry configured to:
receive an array of data for a machine learning (ML) application, the array comprising multiple data values and type selector bits indicating a first data value of the data values is a first datatype and a second data value of the data values is a second datatype different from the first datatype; and
process the data values based on the type selector bits.

18. The compute unit of claim 17, wherein the array further comprises a shared scale for scaling each of the data values.

19. The compute unit of claim 17, wherein the one or more type selector bits includes a plurality of type selector bits, wherein at least a first bit of the plurality of type selector bits indicates the first data value of the multiple data values is the first datatype and at least a second bit of the plurality of type selector bits indicates the second data value of the multiple data values is the second datatype.

20. The compute unit of claim 19, wherein the first bit of the plurality of type selector bits indicates at least two of the multiple data values are the first datatype and the second bit of the plurality of type selector bits indicates at least two of the multiple data values are the second datatype.
